(19) United States
(12) Patent Application Publication
(10) Pub. No.: US 2017/0284201 A1
(43) Pub. Date: Oct. 5, 2017

(54) MALFUNCTION DIAGNOSIS APPARATUS FOR GEAR MOTOR

(71) Applicant: SUMITOMO HEAVY INDUSTRIES, LTD., Tokyo (JP)

(72) Inventors: Kota Suzuki, Aichi (JP); Mikio Komatsu, Aichi (JP); Takashi Haga, Aichi (JP); Akira Yamamoto, Aichi (JP)

(21) Appl. No.: 15/460,073

(22) Filed: Mar. 15, 2017

(30) Foreign Application Priority Data
Mar. 30, 2016 (JP) 2016-068992

(51) Int. Cl. F01C 20/28; F01C 13/00; G01M 13/02; F01C 1/14

(52) U.S. Cl. CPC F01C 20/28; F01C 1/14; F01C 13/00; G01M 13/028

(57) ABSTRACT

A malfunction diagnosis apparatus for a gear motor includes a vibration sensor portion, and a diagnosis unit that determines whether or not an abnormality occurs in the gear motor based on vibration detected by the vibration sensor portion. The vibration sensor portion and the diagnosis unit are installed in the gear motor. The diagnosis unit has a control power source which supplies power to the vibration sensor portion. The vibration sensor portion outputs detected vibration data to the diagnosis unit in a digital format.

### RELATED APPLICATIONS

Priority is claimed to Japanese Patent Application No. JP2016-068992, filed Mar. 30, 2016, the entire content of which is incorporated herein by reference.

### BACKGROUND

### Technical Field

Certain embodiments of the present invention relate to a malfunction diagnosis apparatus for a gear motor.

### Description of Related Art

There is a known malfunction diagnosis apparatus for detecting a malfunction of a gear motor. In the related art, for example, an apparatus has been proposed.

### SUMMARY

According to an aspect of the present invention, there is provided a malfunction diagnosis apparatus for a gear motor including a vibration sensor portion, and a diagnosis unit that determines whether or not an abnormality occurs in the gear motor, based on vibration information detected by the vibration sensor portion.

### BRIEF DESCRIPTION OF THE DRAWINGS

FIG. 1 is a schematic view illustrating the configuration of a malfunction diagnosis apparatus for a gear motor, according to a first embodiment.

FIG. 2 is a block diagram illustrating the function and the configuration of the malfunction diagnosis apparatus for a gear motor in FIG. 1.

FIG. 3 is a block diagram illustrating the function and the configuration of a malfunction diagnosis apparatus for a gear motor, according to a second embodiment.

FIG. 4 is a schematic view illustrating the configuration of a malfunction diagnosis apparatus for a gear motor, according to a third embodiment.

FIG. 5 is a block diagram illustrating the function and the configuration of the malfunction diagnosis apparatus for a gear motor in FIG. 4.

FIG. 6 is a flow chart illustrating an operation of a diagnosis unit in FIG. 4.

FIG. 7 is a flow chart illustrating an operation of the diagnosis unit in FIG. 4.

FIG. 8 is a flow chart illustrating an operation of the diagnosis unit in FIG. 4.

FIG. 9 is a schematic view illustrating the configuration of a malfunction diagnosis apparatus for a gear motor, according to a modification example.

### DETAILED DESCRIPTION

Generally, a malfunction diagnosis apparatus includes a vibration sensor that is disposed in a gear motor, and a diagnosis unit that determines whether or not an abnormality has occurred in the gear motor, based on information from the vibration sensor. Both the vibration sensor and the diagnosis unit are sometimes disposed in the gear motor. In this case, miniaturization of the diagnosis unit becomes a problem.

It is desirable to provide a malfunction diagnosis apparatus for a gear motor, in which a diagnosis unit can be miniaturized.

The vibration sensor portion and the diagnosis unit are installed in the gear motor, and the diagnosis unit has a power supply portion which supplies power to the vibration sensor portion. The vibration sensor portion outputs detected vibration information to the diagnosis unit in a digital format.

An arbitrary combination of the configuration elements described above or an embodiment in which the configuration elements or expressions of the present invention are replaced with each other among a method, an apparatus, and a system is also effective as an aspect of the present invention.

According to the present invention, the diagnosis unit can be miniaturized.

Hereinafter, the same reference symbol will be applied to a configuration element, a member, or a step which is the same as or equal to that illustrated in each drawing, and overlapping description will be appropriately omitted. In addition, in order to make the drawing easy to understand, the members are illustrated in each drawing while being appropriately increased and reduced in size. In addition, in each drawing, the members will be illustrated while omitting a portion which is not important in describing embodiments.

### First Embodiment

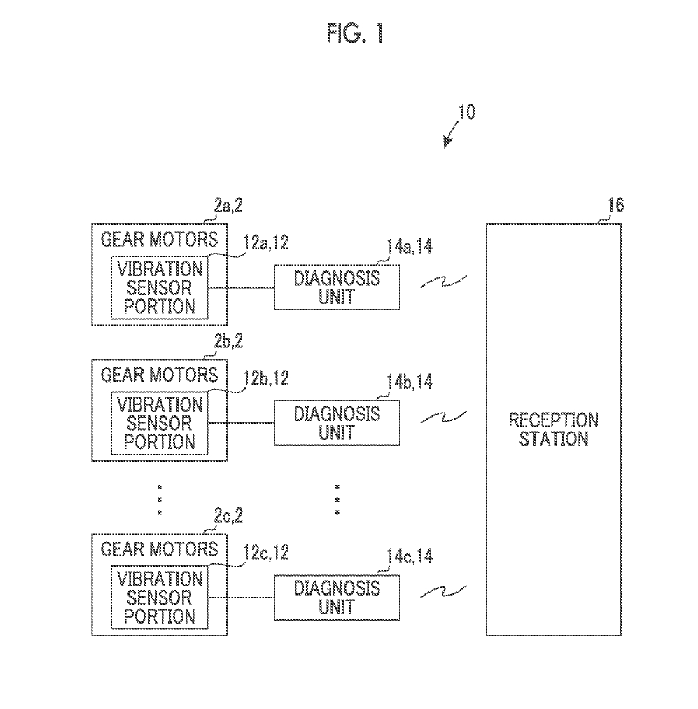

FIG. 1 is a schematic view illustrating the configuration of a malfunction diagnosis apparatus 10 for a gear motor, according to a first embodiment. The malfunction diagnosis apparatus 10 detects an abnormality of gear motors 2a, 2b, and 2c collectively referred to as a gear motor 2 and supports an analysis thereof.

The malfunction diagnosis apparatus 10 includes vibration sensor portions 12a, 12b, and 12c collectively referred to as a vibration sensor portion 12, diagnosis units 14a, 14b, and 14c collectively referred to as a diagnosis unit 14, and a reception station (external apparatus) 16. In the present embodiment, the vibration sensor portions 12a, 12b, and 12c are respectively connected to the diagnosis units 14a, 14b, and 14c through cables. In addition, the diagnosis units 14a, 14b, and 14c are connected to the reception station 16 by radio. The diagnosis units 14a, 14b, and 14c may be connected to the reception station 16 through cables.

The vibration sensor portions 12a, 12b, and 12c are respectively connected to the gear motors 2a, 2b, and 2c. The vibration sensor portion 12 detects vibration occurring in the corresponding gear motor 2 and generates “vibration information” indicating the magnitude of vibration, thereby transmitting the vibration information to the corresponding diagnosis unit 14. FIG. 1 illustrates a case where one vibration sensor portion 12 is attached to each of the gear motors 2. However, two or more vibration sensor portions 12 may be attached to each of the gear motors 2. Naturally, two or more vibration sensor portions 12 may be attached to only a part of the gear motors 2. In addition, as an attachment position of the vibration sensor portion 12 in the gear motor 2, a position suitable for detecting an abnormality may be set through an experiment, a simulation, or the like.

The diagnosis units 14a, 14b, and 14c respectively determine whether or not an abnormality has occurred in the gear motors 2a, 2b, and 2c, based on the vibration information sent from the vibration sensor portions 12a, 12b, and 12c, thereby transmitting determination results to the reception station 16. In addition, when “a transmission request” for vibration information is received from the reception station 16, the diagnosis unit 14 transmits (transfer) the vibration information sent from the vibration sensor portion 12, to the reception station 16.

In the reception station 16, a predetermined display unit displays the determination result regarding each of the gear motors 2 sent from each of the diagnosis units 14. A user can ascertain that an abnormality has occurred in the gear motor 2 by checking the display unit. In addition, the reception station 16 receives a designation of the diagnosis unit 14 (gear motor 2) of which the vibration information is to be transmitted from the user. The reception station 16 sends a transmission request for the vibration information to the diagnosis unit 14. When the vibration information is transmitted from the diagnosis unit 14 in response to the transmission request, the reception station 16 analyzes the vibration information.

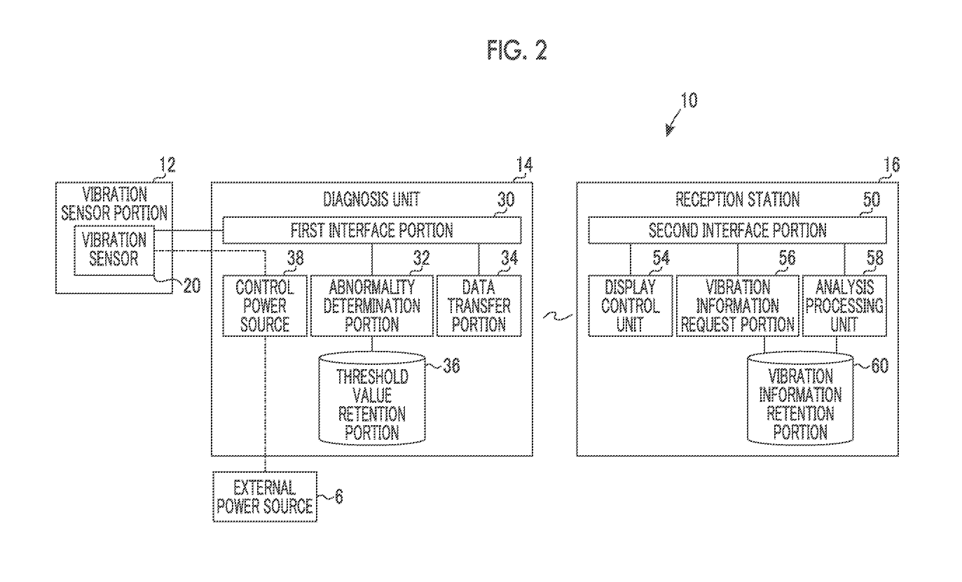

FIG. 2 is a block diagram illustrating the function and the configuration of the malfunction diagnosis apparatus 10. In each of the blocks illustrated in FIG. 2, the hardware thereof can be realized through an element and a mechanical device including a CPU and a memory of a computer, and the software thereof is realized through a computer program or the like. However, in this case, functional blocks realized through cooperation thereof are depicted. Therefore, those skilled in the art understand that the functional blocks can be realized in various forms through combinations of the hardware and the software. The same can also be applied to the block diagrams below.

FIG. 2 representatively illustrates only one for each of the vibration sensor portions 12 and the diagnosis units 14.

The vibration sensor portion 12 includes a vibration sensor 20. The vibration sensor 20 detects vibration of the gear motor 2 and generates vibration information. The vibration sensor 20 is a digital sensor and outputs the vibration information in a digital format. The vibration sensor 20 is operated by power supplied from a control power source 38 (will be described later) of the diagnosis unit 14.

The diagnosis unit 14 includes a first interface portion 30, an abnormality determination portion 32, a data transfer portion 34, a threshold value retention portion 36, and the control power source (power supply portion) 38. The first interface portion 30 executes communication processing with respect to the vibration sensor portion 12 or the reception station 16.

The abnormality determination portion 32 determines whether or not an abnormality has occurred in the gear motor 2, based on the vibration information sent from the vibration sensor portion 12. Hereinafter, determination performed by the abnormality determination portion 32 will be referred to as “abnormality determination”. Specifically, the abnormality determination portion 32 checks the vibration information sent from the vibration sensor portion 12, at uniform intervals. In a case where the magnitude of vibration indicated by the vibration information exceeds the abnormality threshold value retained in the threshold value retention portion 36, it is determined that an abnormality has occurred in the gear motor 2. The abnormality determination is not limited to the example described above. For example, the diagnosis unit 14 may execute the abnormality determination based on the average value or the peak value of the vibration information during a predetermined period of time (for example, 10 seconds) or may suitably perform filtering processing or the like.

The abnormality determination portion 32 transmits the determination result of the abnormality determination to the reception station 16 via the first interface portion 30. The abnormality determination portion 32 may transmit the determination result to the reception station 16 only in a case where it is determined that an abnormality has occurred.

The data transfer portion 34 receives the transmission request for the vibration information transmitted from the reception station 16, via the first interface portion 30. The data transfer portion 34 transmits the vibration information generated by the vibration sensor portion 12 after the transmission request is received, to the reception station 16 via the first interface portion 30. That is, the data transfer portion 34 transfers the vibration information transmitted from the vibration sensor portion 12 to the reception station 16.

The threshold value retention portion 36 retains “the abnormality threshold value” to be used in abnormality determination. The abnormality threshold value is set to a value obtained by multiplying a reference value (normal value) by a coefficient (for example, 1.5 or 2.0). The coefficient may be set based on the knowledge and experience of the user, an experiment, or the like. In addition, the reference value (normal value) may be set based on the knowledge and experience of the user, an experiment, and the like. Otherwise, the diagnosis unit 14 may be caused to automatically measure the vibration information at a normal time for a certain period of time and the average value during the measurement period may be set as the reference value. The abnormality threshold values for gear motors 2 may be different from each other. In addition, in a case where two or more vibration sensor portions 12 are attached to one gear motor 2, the abnormality threshold values for the pieces of vibration information sent from the vibration sensor portion 12 may be different from each other. That is, the abnormality threshold values may be different from each other depending on the attachment position of the vibration sensor portion 12.

The control power source 38 transforms power supplied from an external power source 6 into a voltage suitable for the vibration sensor 20 (for example, step-down) and supplies the transformed power to the vibration sensor 20.

The reception station 16 includes a second interface portion 50, a display control unit 54, a vibration information request portion 56, an analysis processing unit 58, and a vibration information retention portion 60.

The second interface portion 50 executes communication processing with respect to the diagnosis unit 14. In addition, the second interface portion 50 plays a role of displaying information and inputting an operation.

The display control unit 54 receives the determination result transmitted from the diagnosis unit 14, via the second interface portion 50. The display control unit 54 causes the predetermined display unit to display the received determination result, via the second interface portion 50.

The vibration information request portion 56 receives a designation of the diagnosis unit 14 (gear motor 2) of which the vibration information is to be transmitted, from the user via the second interface portion 50. The vibration information request portion 56 sends the transmission request for the vibration information to the diagnosis unit 14. For example, when the user checks the determination result displayed by the display unit and ascertains that an abnormality has occurred in the gear motor 2, the user designates the diagnosis unit 14 corresponding to the gear motor 2 as the diagnosis unit 14 of which the vibration information is to be transmitted. When the vibration information is transmitted based on the transmission request, the vibration information request portion 56 retains the vibration information in the vibration information retention portion 60.

The analysis processing unit 58 detailedly analyzes the vibration information retained in the vibration information retention portion 60. Specifically, the analysis processing unit 58 executes fast Fourier transform (FFT) with respect to the vibration waveform based on the vibration information or executes FFT with respect to the envelope curve of the vibration waveform. The analysis processing unit 58 causes the display unit to display the analysis result, via the second interface portion 50. The user specifies the type of the abnormality which has occurred in the gear motor 2, the site where an abnormality has occurred, or the like by checking the analysis result displayed by the display unit.

An operation of the malfunction diagnosis apparatus 10 configured as above will be described. Here, among a plurality of the gear motors 2, description will be given with reference to an example in a case where a malfunction occurs in the gear motor 2b.

The diagnosis unit 14 executes the abnormality determination based on the vibration information sent from the vibration sensor portion 12. When it is detected that the magnitude of vibration indicated by the vibration information sent from the vibration sensor portion 12b exceeds the abnormality threshold value, the diagnosis unit 14b transmits the determination result regarding the state where an abnormality has occurred to the reception station 16. Meanwhile, the diagnosis units 14a and 14c transmit the determination result regarding the state where no abnormality has occurred to the reception station 16.

The display control unit 54 of the reception station 16 causes the display unit to display the determination result from each of the diagnosis units 14. When the user checks the display unit and ascertains that an abnormality has occurred in the diagnosis unit 14b, the user makes an input such that the vibration information of the diagnosis unit 14b is transmitted. The vibration information request portion 56 transmits the transmission request for the vibration information to the diagnosis unit 14b designated by the user.

When the transmission request is received, the data transfer portion 34 of the diagnosis unit 14b transmits the vibration information of the gear motor 2b detected by the vibration sensor portion 12b thereafter, to the reception station 16.

The analysis processing unit 58 of the reception station 16 receives the vibration information transmitted from the diagnosis unit 14b. The analysis processing unit 58 executes predetermined analysis processing with respect to the received vibration information and causes the display unit to display the analysis result. The user specifies the type of the abnormality which has occurred in the gear motor 2b, the site where an abnormality has occurred, or the like by checking the analysis result displayed by the display unit.

In the above-described malfunction diagnosis apparatus 10 according to the embodiment, as the vibration sensor 20 of the vibration sensor portion 12, the digital sensor which outputs the vibration information in a digital format is used. Therefore, compared to a case where an analog sensor which outputs the vibration information in an analog format is used as the vibration sensor 20, the vibration sensor 20 consumes less power. Accordingly, the diagnosis unit 14 as well as the control power source 38 can be miniaturized.

### Second Embodiment

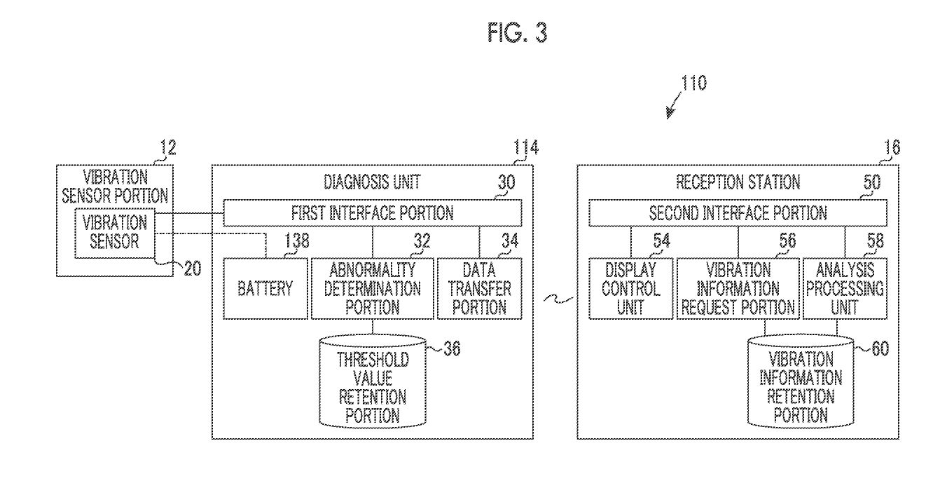

FIG. 3 is a block diagram illustrating the function and the configuration of a malfunction diagnosis apparatus 110 for a gear motor, according to a second embodiment. FIG. 3 corresponds to FIG. 2.

The malfunction diagnosis apparatus 110 includes a plurality of the vibration sensor portions 12, a plurality of diagnosis units 114, and the reception station 16. FIG. 3 representatively illustrates only one for each of the vibration sensor portions 12 and the diagnosis units 114.

The diagnosis unit 114 includes the first interface portion 30, the abnormality determination portion 32, the data transfer portion 34, the threshold value retention portion 36, and a battery (power supply portion) 138.

The battery 138 supplies power having a voltage suitable for the vibration sensor 20 to the vibration sensor 20. The vibration sensor 20 is operated power supplied from the battery 138.

According to the malfunction diagnosis apparatus 110 of the present embodiment, similar to the first embodiment, the vibration sensor 20 consumes relatively less power. Accordingly, the diagnosis unit 14 as well as the battery 138 can be miniaturized. Otherwise, since the vibration sensor 20 consumes less power, consumption of the battery 138 is restrained. Accordingly, the frequency of storing power in the battery 138 can be reduced.

### Third Embodiment

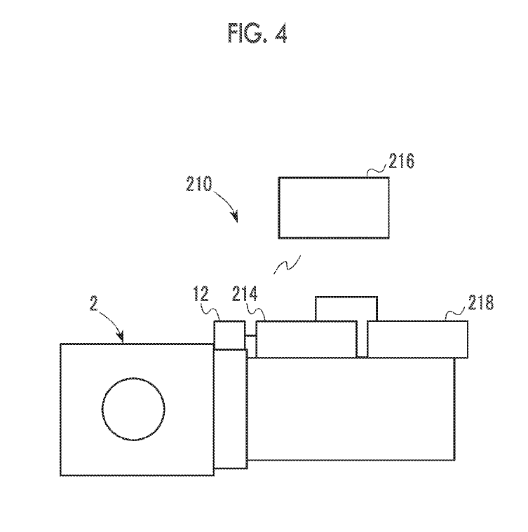

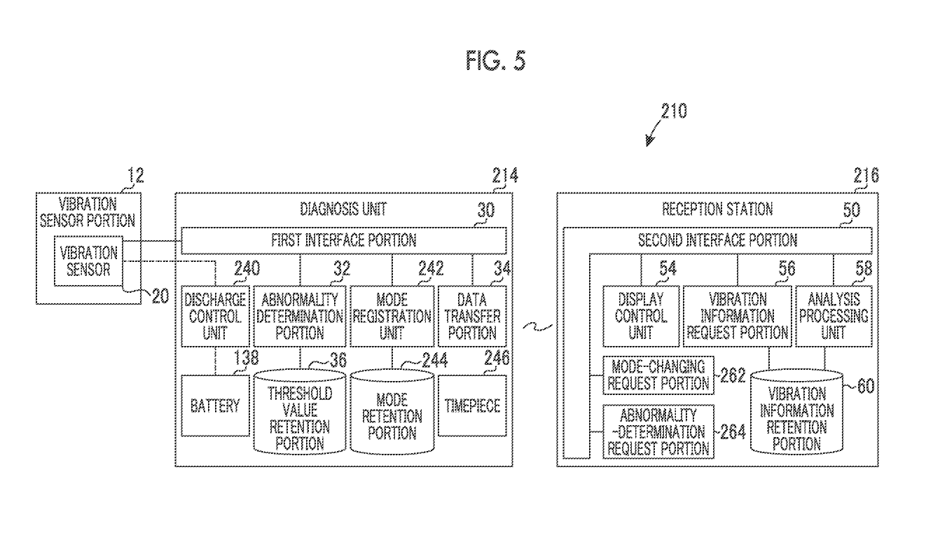

FIG. 4 is a schematic view illustrating the configuration of a malfunction diagnosis apparatus 210 for a gear motor, according to a third embodiment. FIG. 5 is a block diagram illustrating the function and the configuration of the malfunction diagnosis apparatus 210 for a gear motor. FIG. 5 corresponds to FIG. 2. The malfunction diagnosis apparatus 210 includes the vibration sensor portion 12, a diagnosis unit 214, a reception station 216, and a vibration generation module (power generation mechanism) 218.

The vibration generation module 218 is attached to the gear motor 2. The vibration generation module 218 generates power through vibration of the gear motor 2. The power generated by the vibration generation module 218 is stored in the battery 138.

The diagnosis unit 214 includes the first interface portion 30, the abnormality determination portion 32, the data transfer portion 34, the threshold value retention portion 36, the battery 138, a discharge control unit 240, a mode registration unit 242, a mode retention portion 244, and a timepiece 246.

The discharge control unit 240 monitors the power storage amount of the battery 138. In addition, the discharge control unit 240 controls power supplied from the battery 138 to the vibration sensor 20. The detailed function of the discharge control unit 240 will be described later.

Here, it is difficult to execute three types of processing such as supplying power to the vibration sensor portion 12, determining an abnormality by the abnormality determination portion 32, and transmitting the determination result of the abnormality determination at all times, with only power generated by the vibration generation module 218. Therefore, in the present embodiment, the diagnosis unit 214 is operated in any mode among six modes from a first mode to a sixth mode described below and executes the processing thereof at only particular timing.

The mode retention portion 244 retains any of the six modes from the first mode to the sixth mode. The diagnosis unit 214 is operated in the mode retained in the mode retention portion 244. The mode registration unit 242 receives “a change request” of the mode from the reception station 16 via the first interface portion 30. The mode registration unit 242 updates the data retained in the mode retention portion 244 to the mode indicated by the change request.

The reception station 216 includes the second interface portion 50, the display control unit 54, the vibration information request portion 56, the analysis processing unit 58, the vibration information retention portion 60, a mode-changing request portion 262, and an abnormality-determination request portion 264. The mode-changing request portion 262 receives a designation of the operation mode of the diagnosis unit 214 from the user and sends the change request to the mode designated in the diagnosis unit 214. The mode registration unit 242 receives the change request and updates the data retained in the mode retention portion 244. In a case where the diagnosis unit 214 is operated in the third mode as described below, the abnormality-determination request portion 264 receives a predetermined request from the user.

Subsequently, description will be given regarding the operations of the diagnosis unit 214 in a case where the modes from the first mode to the sixth mode are respectively set.

First Mode

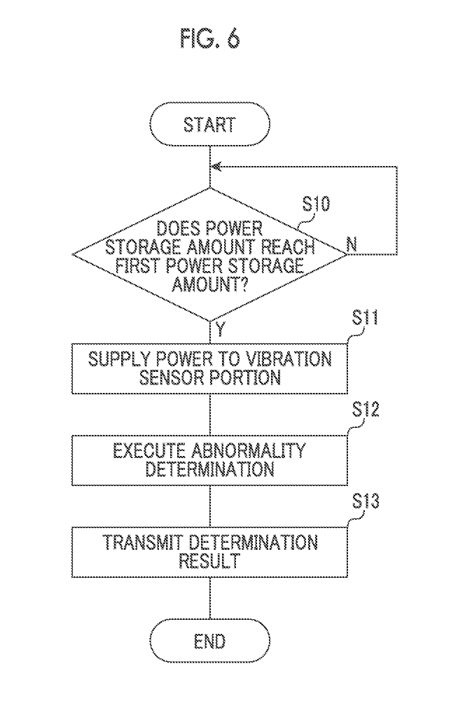

FIG. 6 is a flow chart illustrating an operation of the diagnosis unit 214 in a case where the first mode is set as the operation mode of the diagnosis unit 214. The processing illustrated in FIG. 6 is loop processing repetitively executed at uniform intervals.

The discharge control unit 240 stands by until the power storage amount of the battery 138 reaches a first power storage amount (N in S10). When the power storage amount of the battery 138 reaches the first power storage amount (Y in S10), power is supplied to the vibration sensor portion 12 (S11). Here, “the first power storage amount” indicates a power storage amount required in executing the three types of processing such as supplying power to the vibration sensor portion 12, determining an abnormality by the abnormality determination portion 32, and transmitting the determination result of the abnormality determination performed by the abnormality determination portion 32. The vibration sensor portion 12 is operated by power supplied from the battery 138 and generates the vibration information, thereby transmitting the generated vibration information to the diagnosis unit 214. The abnormality determination portion 32 performs abnormality determination based on the vibration information transmitted from the vibration sensor portion 12 by using power stored in the battery 138 (S12). The abnormality determination portion 32 transmits the determination result of the abnormality determination to the reception station 216 by using power stored in the battery 138 (S13). When the determination result is transmitted, the processing ends temporarily and stands by until the next execution timing. That is, in the first mode, every time the power storage amount of the battery 138 reaches the first power storage amount, the abnormality determination or the like is executed. The transmission of the determination result (S13) may be performed in only a case where it is determined that an abnormality has occurred.

Second Mode

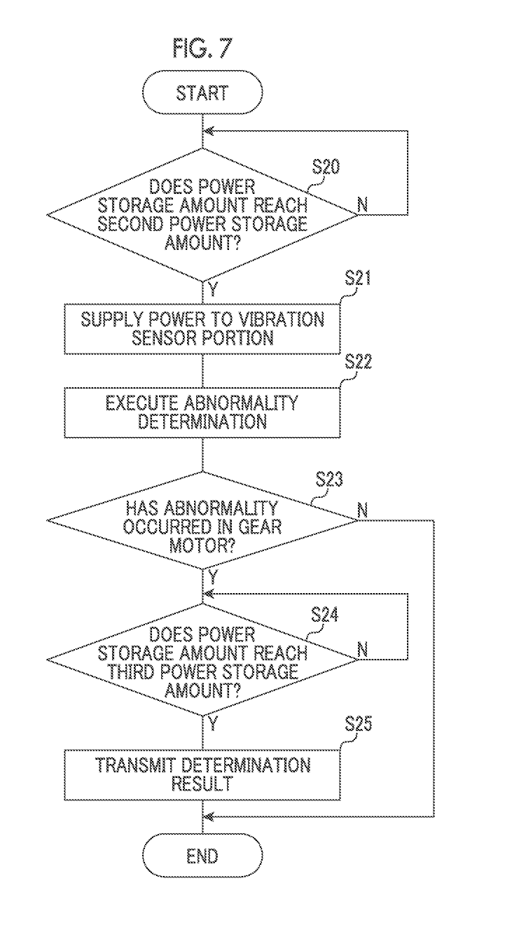

FIG. 7 is a flow chart illustrating an operation of the diagnosis unit 214 in a case where the second mode is set as the operation mode of the diagnosis unit 214. The processing illustrated in FIG. 7 is loop processing repetitively executed at uniform intervals.

The discharge control unit 240 stands by until the power storage amount of the battery 138 reaches a second power storage amount (N in S20). When the power storage amount of the battery 138 reaches the second power storage amount (Y in S20), power is supplied to the vibration sensor portion 12 (S21). Here, “the second power storage amount” indicates a power storage amount required in executing the two types of processing such as supplying power to the vibration sensor portion 12 and determining an abnormality by the abnormality determination portion 32. The vibration sensor portion 12 is operated by power supplied from the battery 138 and generates the vibration information, thereby transmitting the generated vibration information to the diagnosis unit 214. The abnormality determination portion 32 performs abnormality determination based on the vibration information transmitted from the vibration sensor portion 12 by using power stored in the battery 138 (S22). In a case where it is determined that no abnormality has occurred in the gear motor 2 (N in S23), the processing ends temporarily and stands by until the next execution timing. In a case where it is determined that an abnormality has occurred the gear motor 2 (Y in S23), the abnormality determination portion 32 stands by until the power storage amount of the battery 138 reaches a third power storage amount (N in S24). When the power storage amount of the battery 138 reaches the third power storage amount (Y in S24), the determination result is transmitted to the reception station 216 by using power stored in the battery 138. Here, “the third power storage amount” indicates a power storage amount required in transmitting the determination result to the reception station 216 by the abnormality determination portion 32. When the determination result is transmitted, the processing ends temporarily and stands by until the next execution timing. That is, in the second mode, every time the power storage amount of the battery 138 reaches the second power storage amount, the abnormality determination or the like is executed.

Third Mode

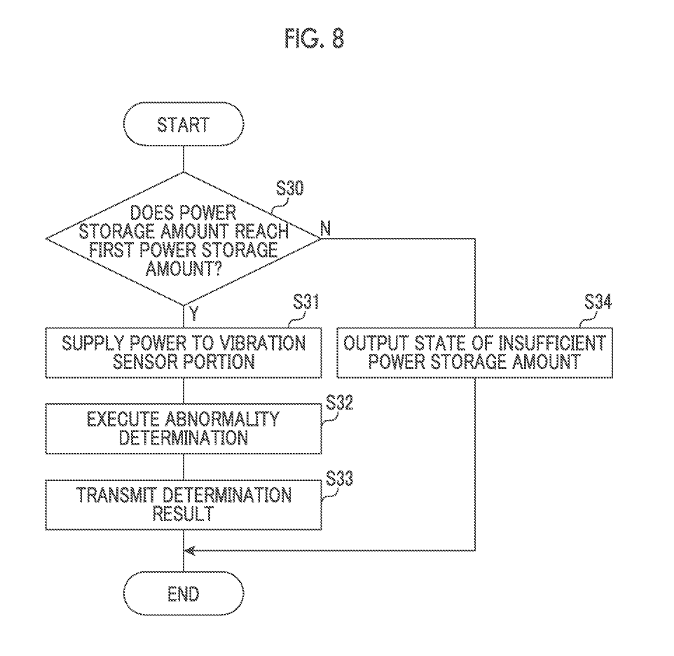

FIG. 8 is a flow chart illustrating an operation of the diagnosis unit 214 in a case where the third mode is set as the operation mode of the diagnosis unit 214. In the third mode, the abnormality-determination request portion 264 of the reception station 216 receives a designation of the diagnosis unit 214 with which the abnormality determination is intended to be executed, from the user, thereby sending the request for the abnormality determination to the diagnosis unit 214. When the request for the abnormality determination is received from the reception station 216, the diagnosis unit 214 executes the processing in FIG. 8.

In a case where the power storage amount of the battery 138 reaches the first power storage amount (Y in S30), the discharge control unit 240 supplies power to the vibration sensor portion 12 (S31). The vibration sensor portion 12 is operated by the power and generates the vibration information, thereby transmitting the generated vibration information to the diagnosis unit 214. The abnormality determination portion 32 performs abnormality determination based on the vibration information transmitted from the vibration sensor portion 12 by using power stored in the battery 138 (S32). The abnormality determination portion 32 transmits the determination result of the abnormality determination to the reception station 216 by using power stored in the battery 138 (S33). In a case where the power storage amount of the battery 138 does not reach the first power storage amount, that is, in a case where the power storage amount of the battery 138 is insufficient (N in S30), the discharge control unit 240 outputs a state of insufficient power-storage to the reception station 216 (S34). That is, in a case where the power storage amount of the battery 138 does not reach the first power storage amount, the processing ends without executing the abnormality determination or the like. The output of the state of insufficient power-storage is not limited to the output with respect to the reception station 16. For example, the output may be lighting or the like of a lamp.

Fourth Mode

In a case where the fourth mode is set as the operation mode of the diagnosis unit 214, when the power source of the diagnosis unit 214 is turned ON or immediately after the power source is turned ON, a series of steps of processing such as supplying power to the vibration sensor portion 12, determining an abnormality by the abnormality determination portion 32, and transmitting the determination result by the abnormality determination portion 32 are executed. The processing of the diagnosis unit 214 executed in this case is similar to that of the case of the third mode, that is, the processing illustrated in FIG. 8. The power source of the diagnosis unit 214 may be turned ON and OFF in association with ON and OFF of the power source of the gear motor 2 or may be turned ON and OFF independently from ON and OFF of the power source of the gear motor 2. For example, the fourth mode may be employed in a case where power cannot be generated such that the abnormality determination or the like can be executed several times a day. In a case where the fourth mode is employed, the abnormality determination or the like is executed by using power stored in the battery 138 through the operation of the gear motor 2 during the previous day.

Fifth Mode

In a case where the fifth mode is set as the operation mode of the diagnosis unit 214, after a lapse of a predetermined period of time from when the power source of the diagnosis unit 214 is turned ON, a series of steps of processing such as supplying power to the vibration sensor portion 12, determining an abnormality by the abnormality determination portion 32, and transmitting the determination result by the abnormality determination portion 32 are executed. The processing of the diagnosis unit 214 executed in this case is similar to that of the case of the third mode, that is, the processing illustrated in FIG. 8. For example, the fifth mode may also be employed in a case where power cannot be generated such that the abnormality determination or the like can be executed several times a day. As “the predetermined period of time” mentioned above, a period of time assumed to be taken for storing power to the extent that the abnormality determination or the like can be executed may be set.

Sixth Mode

In a case where the sixth mode is set as the operation mode of the diagnosis unit 214, when it becomes the set time, a series of steps of processing such as supplying power to the vibration sensor portion 12, determining an abnormality by the abnormality determination portion 32, and transmitting the determination result are executed. Specifically, the discharge control unit 240 acquires the time from the timepiece 246 in a predetermined cycle (for example, cycle per second), and when the acquired time becomes the set time, a series of steps of processing are executed. The processing of the diagnosis unit 214 executed in this case is similar to that of the case of the third mode, that is, the processing illustrated in FIG. 8. For example, the sixth mode may also be employed in a case where power cannot be generated such that the abnormality determination or the like can be executed several times a day. As “the set time” mentioned above, a time assumed to be taken for storing power to the extent that the abnormality determination or the like can be executed may be set. For example, in a case where the power sources of the gear motor 2 and the diagnosis unit 214 are turned ON nine o'clock every morning and it takes three hours to store power to the extent that the abnormality determination or the like can be executed, twelve o'clock or a time thereafter may be set as the set time. A plurality of times may be set as the set time.

According to the malfunction diagnosis apparatus 210 of the present embodiment, an operational effect similar to the operational effect conducted by the malfunction diagnosis apparatus 110 according to the second embodiment is conducted. Moreover, according to the malfunction diagnosis apparatus 210 of the present embodiment, the diagnosis unit 214 is in any mode from the first mode to the sixth mode. Therefore, the abnormality determination or the like can be executed with only power generated by the vibration generation module 218, and thus, an abnormality in the gear motor 2 can be detected.

Hereinbefore, the malfunction diagnosis apparatuses according to the embodiments have been described. The embodiments are examples, and those skilled in the art understand that various modification examples can be made for each of the configuration elements and a combination of each processing processes and such a modification example is also included in the scope of the present invention. Hereinafter, the modification examples will be described.

### Modification Example 1

In the third embodiment, description is given regarding a case where power is stored in the battery 138 by the vibration generation module 218, that is, a case where the power generation mechanism for storing power in the battery 138 is the vibration generation module. However, the embodiment is not limited thereto. For example, the power generation mechanism may be a dynamo which generates power by rotary force of the gear motor 2 or may be a photovoltaic power generator which generates power with sunlight.

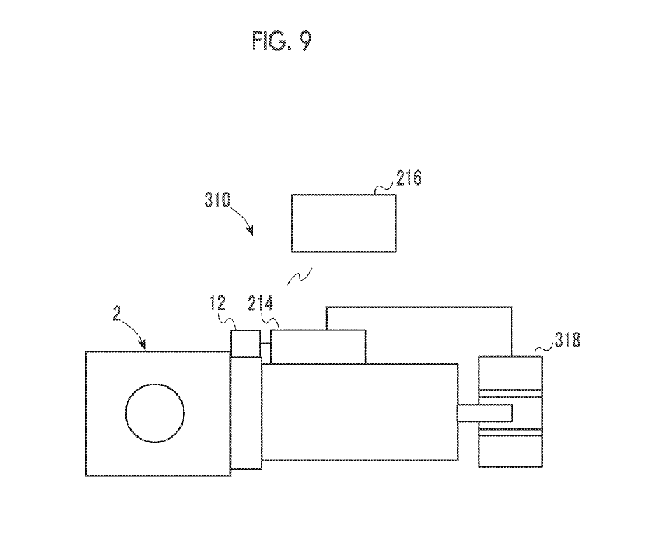

FIG. 9 is a schematic view illustrating the configuration of a malfunction diagnosis apparatus 310 for a gear motor, according to the modification example. FIG. 9 corresponds to FIG. 4. The malfunction diagnosis apparatus 310 according to the present modification example includes the vibration sensor portion 12, the diagnosis unit 214, the reception station 216, and a dynamo (power generation mechanism) 318. The dynamo 318 generates power through rotations of a rotary shaft 3 of the gear motor 2. The power generated by the dynamo 318 is stored in the battery 138. According to the present modification example, an operational effect similar to the operational effect conducted by the malfunction diagnosis apparatus 210 according to the third embodiment is conducted.

### Modification Example 2

In the embodiments, in the third mode to the sixth mode, in a case where the power storage amount of the battery 138 does not reach the first power storage amount, the abnormality determination or the like is not executed. In the modification example, for example, if the power storage amount of the battery 138 reaches the second power storage amount, that is, if the power storage amount of the battery 138 reaches the power storage amount required in executing two types of processing such as supplying power to the vibration sensor portion 12 and determining an abnormality by the abnormality determination portion 32, the abnormality determination or the like (in a case of FIG. 9, S31 to S33) may be executed. In this case, after standing by until the power storage amount of the battery 138 reaches the third power storage amount, that is, after standing by until the power storage amount of the battery 138 reaches the power storage amount required in transmitting the determination result to the reception station 216 by the abnormality determination portion 32, the determination result may be transmitted to the reception station 216.

### Modification Example 3

In the embodiments, description has been given regarding a case where only when vibration is detected by the vibration sensor portion 12, power is supplied from the diagnosis unit 14 to the vibration sensor portion 12. However, standby power which is extremely smaller than that when vibration is detected may be supplied from the diagnosis unit 14 to the vibration sensor portion 12 at all times.

An arbitrary combination of the embodiments and the modification examples mentioned above is also useful as an embodiment of the present invention. A new embodiment made through a combination has the effect of each of the embodiments and the modification examples.

1. A malfunction diagnosis apparatus for a gear motor, comprising:
a vibration sensor portion; and
a diagnosis unit that determines whether or not an abnormality occurs in the gear motor, based on vibration information detected by the vibration sensor portion,
wherein the vibration sensor portion and the diagnosis unit are installed in the gear motor,
wherein the diagnosis unit has a power supply portion which supplies power to the vibration sensor portion, and
wherein the vibration sensor portion outputs detected vibration information to the diagnosis unit in a digital format.

2. The malfunction diagnosis apparatus for a gear motor, according to claim 1, further comprising:
a power generation mechanism that is mounted in the gear motor,
wherein the diagnosis unit supplies power generated by the power generation mechanism to the vibration sensor portion and performs determination by using the power.

3. The malfunction diagnosis apparatus for a gear motor, according to claim 2,
wherein the power supply portion is power storage means which stores power generated by the power generation mechanism, and
wherein the diagnosis unit supplies power to the vibration sensor portion and performs determination when the power storage amount of the power storage means reaches a predetermined value.

4. The malfunction diagnosis apparatus for a gear motor, according to claim 2,
wherein the power supply portion is power storage means which stores power generated by the power generation mechanism, and
wherein the diagnosis unit supplies power to the vibration sensor portion and performs determination by using power stored in the power storage means when a request is received from an external apparatus.

5. The malfunction diagnosis apparatus for a gear motor, according to claim 2,
wherein the power supply portion is power storage means which stores power generated by the power generation mechanism, and
wherein the diagnosis unit supplies power to the vibration sensor portion and performs determination by using power stored in the power storage means when a power source of the diagnosis unit is turned ON or after a lapse of a predetermined time from when the power source of the diagnosis unit is turned ON.

6. The malfunction diagnosis apparatus for a gear motor, according to claim 2,
wherein the power supply portion is power storage means which stores power generated by the power generation mechanism, and
wherein the diagnosis unit supplies power to the vibration sensor portion and performs determination when the time obtained from a timepiece included in the diagnosis unit becomes a set time.

7. The malfunction diagnosis apparatus for a gear motor, according to claim 3,
wherein in a case where it is determined that an abnormality occurs in the gear motor, the diagnosis unit waits until power required in a transmission to the external apparatus is stored in the power storage means and transmits a determination result to the external apparatus.

8. The malfunction diagnosis apparatus for a gear motor, according to claim 3,
wherein in a case where power required in supplying power to the vibration sensor portion and performing determination is not stored in the power storage means, the diagnosis unit outputs a state of insufficient power-storage without supplying power to the vibration sensor portion and performing determination.
